(19) United States
(12) Patent Application Publication
(10) Pub. No.: US 2026/0077591 A1
(43) Pub. Date: Mar. 19, 2026

(54) LIQUID EJECTION HEAD AND LIQUID EJECTION APPARATUS

(71) Applicant: CANON KABUSHIKI KAISHA, Tokyo (JP)

(72) Inventors: YOSHIYUKI NAKAGAWA, Kanagawa (JP); TAKASHI KATO, Kanagawa (JP)

(21) Appl. No.: 19/327,642

(22) Filed: Sep. 12, 2025

(30) Foreign Application Priority Data
Sep. 17, 2024 (JP) 2024-160046

(51) Int. Cl. B41J 2/14; B41J 2/045; B41J 2/17

(52) U.S. Cl. CPC B41J 2/1404; B41J 2/0458; B41J 2/14056; B41J 2/14072; B41J 2/1707; B41J 2002/14491; B41J 2202/12

(57) ABSTRACT

A liquid ejection head is provided, in which first flow passage with which a one end of a first individual flow passage communicates, a second flow passage with which a the other end of the first individual flow passage and a one end of a second individual flow passage communicate, a third flow passage with which a the other end of the second individual flow passage communicates, and a plurality of first, second, and third openings that are disposed respectively in the first flow passage, the second flow passage, and the third flow passage and cause liquid to flow in or flow out are included, and, when sizes of non-open parts between two first openings, two second openings, and two third openings that are adjacent to each other in a first direction are respectively denoted by D1, D2, and D3, D1>D2 and D3>D2 are satisfied.

### BACKGROUND

### Field of the Technology

The present disclosure relates to a liquid ejection head and a liquid ejection apparatus.

### Description of the Related Art

In a circulation type liquid ejection apparatus, a liquid ejection head circulates ink to discharge air bubbles in a flow passage and suppress increase in viscosity of ink near an ejection nozzle. As a method of circulating ink, there is a differential pressure system that uses a pressure difference. In the differential pressure system, by using a pressure adjustment mechanism or the like, the pressure on the inner side that supplies ink to an ejection nozzle is caused to be higher than the pressure on the outer side that collects the ink, whereby the ink is caused to flow from the inner side to the outer side. At this point of time, in order to circulate the ink, it is necessary to return the ink that has flowed to the outer side to the inner side, hence a pump is required as a mechanism for that purpose. A configuration may be provided for a pump to be located outside of the head of the recording apparatus main body to circulate the liquid between a liquid ejection head and the main body or the like. Alternatively, a pump may be provided inside of the liquid ejection head to circulate the liquid in the liquid ejection head. However, such a differential-pressure circulation method requires mechanisms such as a pressure adjusting mechanism and a pump, and therefore, the recording apparatus main body and the head may increase in size.

Thus, a method for circulating ink not relying on the differential pressure system has been studied. More specifically, in addition to a first energy generating element that generates energy for ejecting ink, a second energy generating element that generates energy for causing liquid to flow is arranged in an individual flow passage communicating with the ejection nozzle. A mechanism is known that circulates ink by driving the second energy generating element to cause the ink to flow in an individual flow passage. Japanese Patent Application Publication No. 2020-104312 discusses a configuration in which a flow passage extending in a direction intersecting with an ejection nozzle array, in which a plurality of ejection nozzles is arranged, is provided, and the first energy generating element and the second energy generating element are included in the flow passage.

In a liquid ejection head including a first energy generating element and a second energy generating element, there is a likelihood that the temperature of the liquid ejection head will excessively rise due to heat generated by driving the second energy generating element to cause the liquid to flow.

### SUMMARY

The present disclosure addresses shortcomings of conventional systems and suppresses excessive temperature rise in a liquid ejection head including a first energy generating element used for ejecting liquid to an individual flow passage communicating with an ejection nozzle and a second energy generating element used for causing the liquid to flow.

An aspect of the present disclosure provides a liquid ejection head that includes a first ejection nozzle array formed of a plurality of ejection nozzles arranged in a first direction; a second ejection nozzle array formed of a plurality of ejection nozzles arranged in the first direction, the second ejection nozzle array being aligned with the first ejection nozzle array in a second direction intersecting with the first direction; a plurality of first individual flow passages communicating with respective ejection nozzles of the plurality of ejection nozzles of the first ejection nozzle array and extending in the second direction; a plurality of second individual flow passages communicating with respective ejection nozzles of the plurality of ejection nozzles of the second ejection nozzle array and extending in the second direction; a plurality of first energy generating elements disposed at positions corresponding to respective ejection nozzles in the plurality of first individual flow passages and the plurality of second individual flow passages, the first energy generating elements configured to generate energy for ejecting liquid from the ejection nozzles; a plurality of second energy generating elements aligned with respective first energy generating elements in the second direction in the plurality of first individual flow passages and the plurality of second individual flow passages, the second energy generating elements configured to generate energy for causing liquid to flow; a first flow passage disposed on a side of the second ejection nozzle array opposite to the first ejection nozzle array in the second direction, the first flow passage configured to communicate with first ends of the plurality of first individual flow passages; a second flow passage disposed between the first ejection nozzle array and the second ejection nozzle array in the second direction, the second flow passage configured to communicate with second ends of the plurality of first individual flow passages and first ends of the plurality of second individual flow passages; a third flow passage disposed on a side of the first ejection nozzle array opposite to the second ejection nozzle array in the second direction, the third flow passage configured to communicate with second ends of the plurality of second individual flow passages; a plurality of first openings arranged in the first direction and disposed in the first flow passage, a first opening of the plurality of first openings configured for liquid to flow into or flow out of the first flow passage; a plurality of second openings arranged in the first direction and disposed in the second flow passage, a second opening of the plurality of second openings configured for liquid to flow into or flow out of the second flow passage; and a plurality of third openings arranged in the first direction and disposed in the third flow passage, a third opening of the plurality of third opening configured for liquid to flow into or flow out of the third flow passage, with D1>D2 and D3>D2, with D1 being a size of a non-open part between two first openings adjacent to each other in the first direction, D2 being a size of a non-open part between two second openings adjacent to each other in the first direction, and D3 being a size of a non-open part between two third openings adjacent to each other in the first direction.

Features of the present disclosure will become apparent from the following description of embodiments with reference to the attached drawings. The following description of embodiments is described by way of example.

### BRIEF DESCRIPTION OF THE DRAWINGS

FIG. 1A is a perspective view illustrating the configuration of a liquid ejection apparatus in a case where a main ink tank as a liquid storage unit is disposed outside of the liquid ejection head according to Example 1.

FIG. 1B is a perspective view illustrating the configuration of a liquid ejection apparatus in a case where a main ink tank is not provided outside of a liquid ejection head, and an ink tank is provided in the liquid ejection head.

FIG. 2A is an exploded perspective view illustrating a liquid ejection head according to Example 1.

FIG. 2B is a diagram illustrating a configuration in which an ejection nozzle array of ink of four colors is disposed in one liquid ejection chip, and ink of four colors can be ejected using one liquid ejection chip.

FIG. 2C is a diagram illustrating a configuration in which ejection nozzles of ink of two colors are disposed in one liquid ejection chip, and ink of four colors can be ejected using two liquid ejection chips.

FIG. 2D is a diagram illustrating a configuration in which an ejection nozzle of ink of one color is disposed in one liquid ejection chip, and ink of four colors can be ejected using four liquid ejection chips.

FIG. 3A is a diagram illustrating a configuration near the ejection nozzle of the liquid ejection head in a straight-type ink circulation configuration according to Example 1.

FIG. 3B is a cross-sectional view taken along line AA in FIG. 3A.

FIG. 3C is a cross-sectional view taken along line AA in FIG. 3A illustrating a different configuration from FIG. 3B.

FIG. 3D is a cross-sectional view taken along line AA in FIG. 3A illustrating the flow of ink ejected from the ejection nozzle.

FIG. 4A is a diagram illustrating air bubbles generated by driving a second energy generating element in a straight-type ink circulation configuration according to Example 1.

FIG. 4B is a diagram illustrating the flow of ink in an air bubble shrinking process in the straight-type ink circulation configuration according to Example 1.

FIG. 4C is a diagram illustrating the flow of ink after removal of air bubbles.

FIG. 5A is a diagram illustrating a state in which a recording operation using a liquid ejection apparatus is temporarily suspended in the straight-type ink circulation configuration according to Example 1.

FIG. 5B is a diagram illustrating a state acquired immediately after a circulation flow is generated by a second energy generating element after the state in FIG. 5A in the straight-type ink circulation configuration according to Example 1.

FIG. 5C is a diagram illustrating a state of a case in which a recording operation is temporarily suspended again after FIG. 5B in the straight-type ink circulation configuration according to Example 1.

FIG. 5D is a diagram illustrating a state acquired immediately after a circulation flow is generated again by a second energy generating element after FIG. 5C in the straight-type ink circulation configuration according to Example 1.

FIG. 6A is a diagram illustrating a state of a case in which a recording operation using a liquid ejection apparatus is temporarily suspended in a U-shaped ink circulation configuration of a comparative example.

FIG. 6B is a diagram illustrating a state acquired immediately after a circulation flow is generated by a second energy generating element after FIG. 6A in the U-shaped ink circulation configuration of the comparative example.

FIG. 6C is a diagram illustrating a state of a case in which a recording operation is temporarily suspended again after FIG. 6B in the U-shaped ink circulation configuration of the comparative example.

FIG. 6D is a diagram illustrating a state acquired immediately after a circulation flow is generated again by a second energy generating element after FIG. 6C in the U-shaped ink circulation configuration of the comparative example.

FIG. 7A is a diagram illustrating a liquid ejection head in the U-shaped ink circulation configuration of the comparative example.

FIG. 7B is a cross-sectional view taken along line AA in FIG. 7A in the U-shaped ink circulation configuration of the comparative example.

FIG. 7C is a diagram illustrating a place near an individual flow passage in FIG. 7A in the U-shaped ink circulation configuration of the comparative example.

FIG. 8 is a diagram illustrating a control configuration of a liquid ejection apparatus according to Example 1.

FIG. 9A is a diagram illustrating a configuration near an ejection nozzle of the liquid ejection head according to Example 1.

FIG. 9B is a cross-sectional view taken along line AA in FIG. 9A.

FIG. 9C is a cross-sectional view taken along line AA in FIG. 9A illustrating a different configuration from FIG. 9B.

FIG. 10 is a diagram illustrating a liquid ejection head according to a modification of Example 1.

FIG. 11A is a diagram illustrating a configuration near an ejection nozzle of a liquid ejection head according to Example 2.

FIG. 11B is a cross-sectional view taken along line AA in FIG. 11A.

FIG. 12 is a block diagram illustrating a control configuration of the liquid ejection apparatus according to Example 1.

### DESCRIPTION OF THE EMBODIMENTS

In the following, embodiments of the present disclosure will be described in detail with reference to the accompanying drawings. Note that the following embodiments do not limit the subject matter of the present disclosure, and not all of the combinations of features described in the embodiments are necessarily essential to the solution according to the present disclosure. The same components are denoted by the same reference numerals. In the description below, a basic configuration according to the present disclosure is first explained, followed by explanation of characteristic components according to the present disclosure.

### Example 1

A liquid ejection apparatus 50 according to Example 1 of the present disclosure will now be described. The liquid ejection apparatus 50 is an inkjet recording apparatus that uses an inkjet recording method, and includes a liquid ejection head 1 capable of ejecting ink as liquid.

### <Liquid Ejection Apparatus>

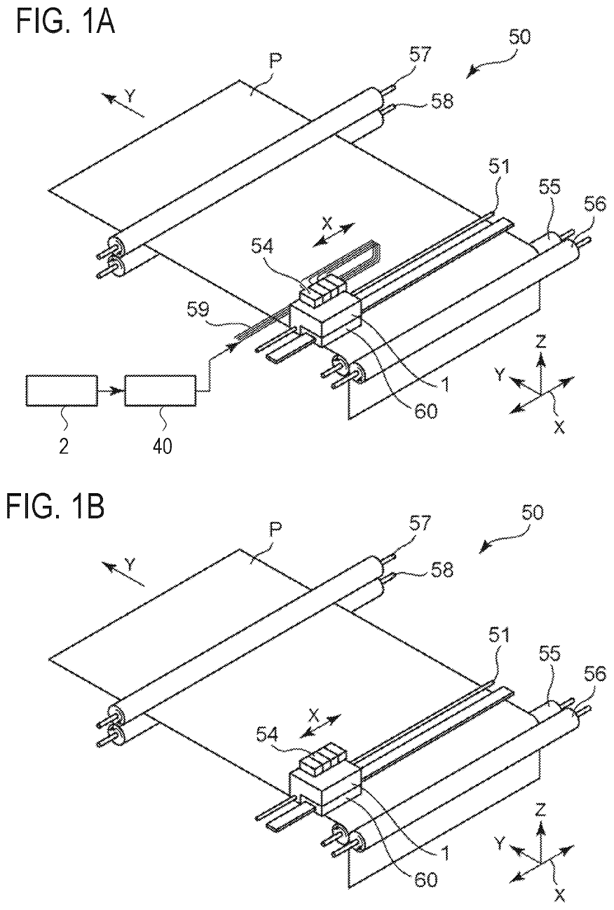

FIGS. 1A and 1B each are a perspective view illustrating the configuration of a liquid ejection apparatus 50 according to Example 1. The liquid ejection apparatus 50 illustrated in each of FIGS. 1A and 1B is a liquid ejection apparatus (a serial-type liquid ejection apparatus) of a form in which image recording is performed by ejecting liquid onto a recording medium P using a liquid ejection head 1 scanning in a direction intersecting with a conveyance direction of a recording medium P. The present disclosure is not limited to the serial-type liquid ejection apparatus and can be applied also to a liquid ejection apparatus of a page wide-type in which image recording is performed by ejecting liquid onto a recording medium conveyed in a conveyance direction using a line head (a page wide-type head) that is long in a page width direction of the recording medium. The liquid ejection head 1 according to Example 1 can eject ink of four types including black (K), cyan (C), magenta (M), and yellow (Y) and record a full-color image using such ink. The ink that can be ejected from the liquid ejection head 1 is not limited to the ink of four types described above. The present disclosure can be applied also to a liquid ejection head that can eject ink of other types, and the types and the number of inks ejected from the liquid ejection head are not particularly limited.

In the liquid ejection apparatus 50, the liquid ejection head 1 is mounted in a carriage 60. The carriage 60 reciprocates along a guide shaft 51 in a main scanning direction (X direction). The recording medium P is conveyed by conveyance rollers 55, 56, 57, and 58 that are conveyance members in a sub scanning direction (Y direction) intersecting with the main scanning direction. In Example 1, the main scanning direction and the sub scanning direction are orthogonal to each other. In each drawing referred to below, a Z direction represents a vertical direction and intersects with an X-Y plane that is defined by an X direction and a Y direction. In Example 1, the Z direction intersects with the X-Y plane.

FIG. 1A illustrates a configuration in which a main ink tank 2 as a liquid storage unit is provided outside of the liquid ejection head 1. The ink stored in the main ink tank 2 is supplied to a sub-ink tank 54 of the liquid ejection head 1 side through an ink supply tube 59 and the like by a drive force of an external pump 40. On the other hand, FIG. 1B illustrates a configuration in which no main ink tank 2 is provided outside of the liquid ejection head 1, and an ink tank 54 is included in the liquid ejection head 1. This configuration may be a configuration in which the liquid ejection head 1 is provided integrally with the ink tank 54 and is attachable/detachable to/from the carriage 60. In addition, a configuration, in which the liquid ejection head 1 is provided integrally with the carriage 60, and only the ink tank 54 is attachable and detachable, may be employed. The external pump 40 supplying ink to the ink tank 54 is a supply unit for supplying ink to the liquid ejection head 1. Example 1 is described for the configuration illustrated in FIG. 1A as an example.

The liquid ejection head 1 is configured to include individual ejection units to be described below. As described herein, the individual ejection unit is a recording element unit in which an ejection nozzle used for ejecting liquid, and an individual flow passage communicating with the ejection nozzle are formed. A pressure chamber is formed at a position corresponding to the ejection nozzle of the individual flow passage, and a first energy generating element (ejection energy generating element) generating energy for ejecting liquid from the ejection nozzle is provided in the pressure chamber. At a position different from that of the first energy generating element in the individual flow passage, a second energy generating element (flow energy generating element) generating energy for causing liquid to flow is provided. The liquid ejection head 1 includes a plurality of individual ejection units, and has a supply flow passage for supplying the liquid to the individual flow passage in each individual ejection unit.

There are cases in which ejection of liquid becomes unstable due to evaporation of volatile components such as moisture and the like of liquid from the ejection nozzle of the liquid ejection head 1, concentration of solid contents near the ejection nozzle in accordance with the evaporation and the like, and, in order to prevent that, various innovations have been considered. For example, in the liquid ejection apparatus 50, a cap member, which is capable of covering an ejection nozzle surface, on which the ejection nozzle of the liquid ejection head 1 is formed, may be provided at a position offset from the conveyance passage of the recording medium P in the X direction. The cap member covers the ejection nozzle surface of the liquid ejection head 1 when a recording operation is not being performed or the like and is used for preventing the ejection nozzle from being dried and protection of the ejection nozzle.

In addition, an ink suction mechanism may be provided. In a case in which the ink suction mechanism is provided, the cap member is used in an ink suctioning operation for suctioning ink from the ejection nozzle and the like. By performing this ink suctioning operation, it is possible to refresh the ink near the ejection nozzle and to maintain the image quality of images to be obtained.

It is also possible to discard the thickened ink by executing ejection that is called preliminary ejection (pre-ejection) while the recording operation is not being performed. Such preliminary ejection may be performed also during the recording operation with an amount of ink that would be unnoticeable in terms of the image quality at a position on a recording medium (paper sheet preliminary ejection/in-page preliminary ejection). Although such a method greatly contributes to improvement of image quality, an amount of ink is wasted because some of the ink has to be discarded to refresh the ejection nozzle.

In relation to this demand, by providing a second energy generating element (fluid energy generating element) in the individual flow passage and circulating the ink through the flow passage, it is possible to inhibit drying of the ejection nozzle and thickening of the ink near the ejection nozzle, while suppressing the amount of waste ink. The number of times that preliminary ejection or suction recovery is performed can be reduced. By reducing the number of preliminary ejection operations and the like, the throughput and the yield thereof can be improved.

The second energy generating element does not need to be provided to all the individual ejection units of the liquid ejection head. In a case in which the second energy generating element is provided in some of the individual ejection units, the above-described effect can be achieved more effectively than in a case in which no second energy generating elements are provided.

It is also possible for the liquid ejection head 1 to have a configuration, in which all the portions corresponding to the ink of four types are provided with the second energy generating elements, or a configuration, in which only a portion corresponding to one of the inks is provided with the second energy generating element. The liquid ejection head 1 may be configured to circulate none of the four types of ink, but only at least one type of ink.

### <Liquid Ejection Head>

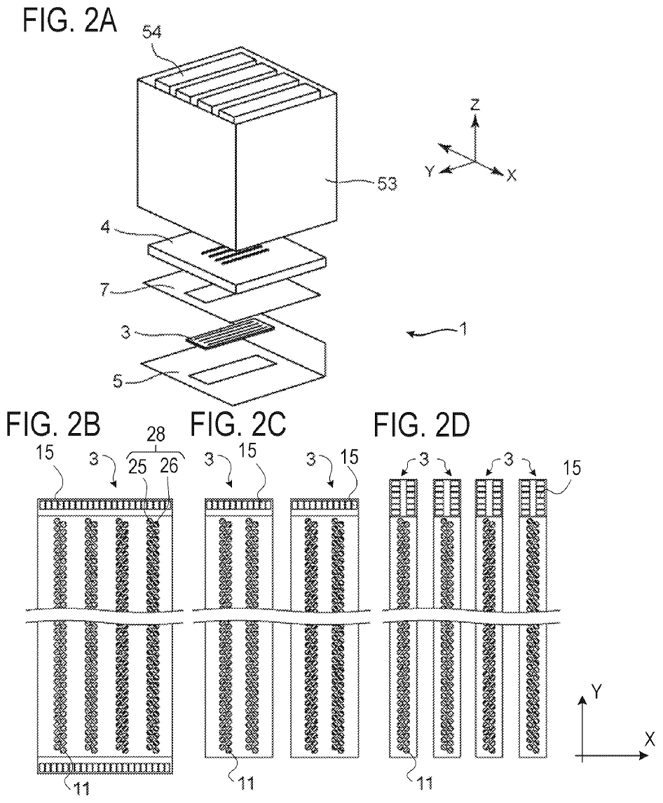

The configuration of the liquid ejection head 1 according to Example 1 will now be explained. FIGS. 2A to 2D are diagrams illustrating the configuration of the liquid ejection head 1 according to Example 1. FIG. 2A is an exploded perspective view of the liquid ejection head 1.

The liquid ejection head 1 includes four sub-ink tanks 54 for temporarily storing the ink and a liquid ejection chip 3 for causing the ink supplied from the sub-ink tanks 54 to be ejected onto a recording medium P.

The liquid ejection head 1 also includes a first support member 4, a second support member 7, and an electric wiring member 5 (electric wiring tape). The liquid ejection chip 3 is connected to one surface of the first support member 4, and the sub-ink tanks 54 are connected to the other surface. The first support member 4 has flow passages passing therethrough from the one surface to the other surface, and the first support member 4 sends the ink supplied from the sub-ink tank 54 to the liquid ejection chip 3, while supporting the liquid ejection chip 3.

The second support member 7 is connected to the first support member 4 on the surface where the liquid ejection chip 3 is connected. The second support member 7 has an opening through which the liquid ejection chip 3 can pass, and the second support member 7 is connected to the first support member 4, with the liquid ejection chip 3 being positioned inside of the opening. The second support member 7 also serves to support the electric wiring member 5.

The electric wiring member 5 is electrically connected to the liquid ejection chip 3, and sends ejection signals for ejecting the ink, which are received from the main body of the liquid ejection apparatus 50 or the like, to the liquid ejection chip 3.

The liquid ejection head 1 according to Example 1 is fixed to and supported by the carriage 60 of the liquid ejection apparatus 50, via a positioning unit and electrical contacts provided to the carriage 60. The liquid ejection head 1 carries out recording on the recording medium P by moving together with the carriage 60 in the main scanning direction (X direction) while ejecting ink.

Ink supply tubes 59 are provided on the external pumps 40 connected to the main ink tanks 2, each of which serves as an ink supply source (FIG. 1A). A liquid connector is provided at the tip end of the ink supply tube 59. When the liquid ejection head 1 is mounted on the liquid ejection apparatus 50, the liquid connector provided at the tip end of the ink supply tube 59 is liquid-tight connection is provided to a liquid connector insertion port that is a liquid introduction port provided in a casing of the liquid ejection head 1. As a result, an ink supply passage is formed from the ink tank 2 to the liquid ejection head 1 via the external pump 40. In Example 1, because four types of ink are used, four sets of the ink tank 2, the external pump 40, the ink supply tube 59, and the sub-ink tank 54 are provided in total in correspondence with respective inks. Four ink supply channels corresponding to respective inks are independently formed.

As described above, the liquid ejection apparatus 50 is provided with an ink supply system for supplying ink from the ink tank 2 outside of the liquid ejection head 1. Note that the liquid ejection apparatus 50 is not provided with an ink collecting system for collecting the ink from the liquid ejection head 1 into the ink tank 2. Therefore, although being provided with a liquid connector insertion port for connecting the ink supply tube 59 of the ink tank 2, the liquid ejection head 1 is not provided with a connector insertion port for connecting a tube for collecting the ink from the liquid ejection head 1 into the ink tank 2. The liquid connector insertion ports are provided correspondingly to the respective inks.

FIGS. 2B, 2C, and 2D are diagrams illustrating configuration examples of liquid ejection chips 3 constituting the liquid ejection head 1. In each liquid ejection chip 3, an ejection nozzle 11 and a pad 15 used for electrical mounting are provided. FIG. 2A is illustrated in a chip configuration of FIG. 2B.

The liquid ejection head 1 can eject ink of four colors. The four colors are, for example, black, cyan, magenta, and yellow. In the liquid ejection chip 3, an ejection nozzle array 28 is formed for each color of ink. One ejection nozzle array 28 is formed of a first row 25 and a second row 26 each formed of a plurality of ejection nozzles 11 arranged at equal intervals in the Y direction (a first direction), and the first row 25 and the second row 26 are arranged to be aligned in the X direction (a second direction). The ejection nozzles 11 included in the first row 25 and the ejection nozzles 11 included in the second row 26 are displaced from each other in the Y direction. Although the configuration in which the ejection nozzle array 28 is formed of a plurality of ejection nozzles 11 aligned in two rows is illustrated, a configuration in which the ejection nozzle array 28 is formed of a plurality of ejection nozzles 11 aligned in one row may be employed.

FIG. 2B illustrates a configuration in which ejection nozzle arrays 28 of inks of four colors are disposed in one liquid ejection chip 3, and one liquid ejection chip 3 can eject four colors of ink. In addition, a configuration in which two rows of ejection nozzle arrays 28 are provided only for black, and five rows of ejection nozzle arrays 28 in total are provided in four colors may be employed.

FIG. 2C illustrates a configuration in which ejection nozzles of inks of two colors are provided in one liquid ejection chip 3, and two liquid ejection chips 3 can eject inks of four colors. As a configuration in which two liquid ejection chips 3 are mounted, two liquid ejection chips 3 may be mounted in one liquid ejection head 1, or two liquid ejection heads 1 in which one liquid ejection chip 3 is mounted may be prepared.

FIG. 2D illustrates a configuration in which one liquid ejection chip 3 is provided with an ejection nozzle of an ink of one color, and four liquid ejection chips 3 can eject inks of four colors. As a configuration in which four liquid ejection chips 3 are mounted, four liquid ejection chips 3 may be mounted in one liquid ejection head 1, and four liquid ejection heads 1 in which one liquid ejection chip 3 is mounted may be prepared.

As illustrated in FIGS. 2C and 2D, in case in which the liquid ejection chip 3 is divided into a plurality of chips, all the chips do not have to have the same chip length. Furthermore, various combinations of other colors for the chips are possible, and the same applies in a case in which the total number of colors is larger than four.

### <Straight-Type Ink Circulation Configuration>

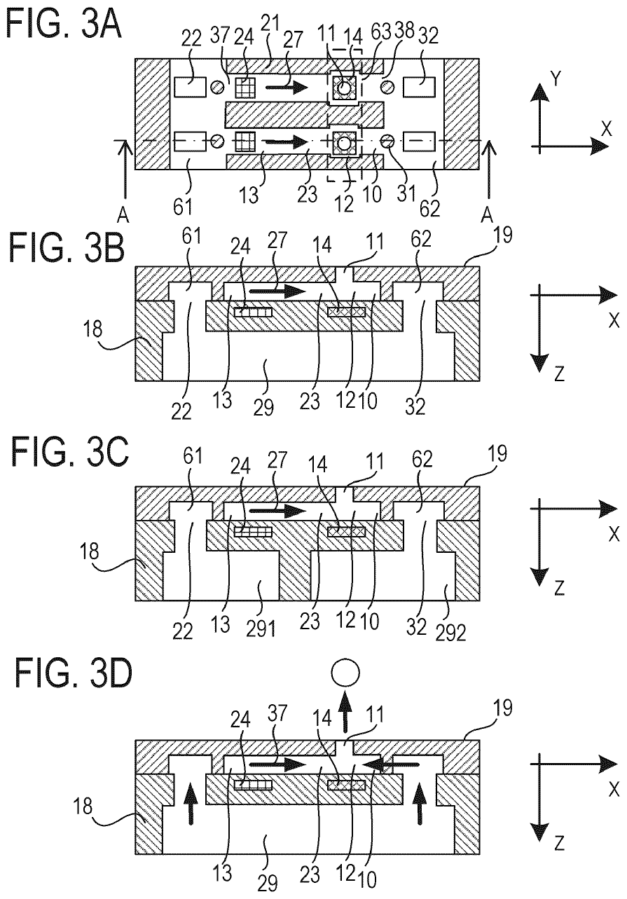

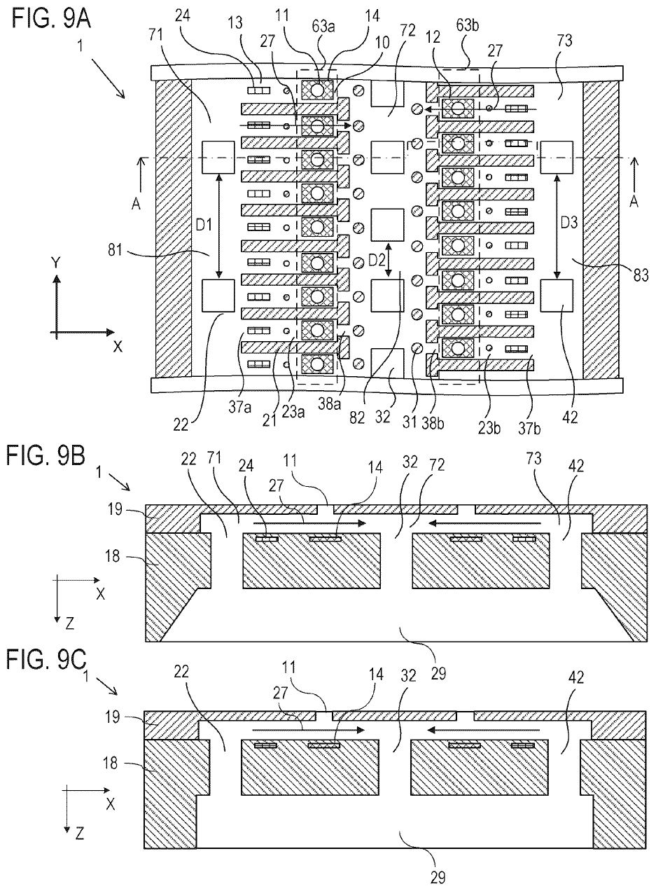

FIGS. 3A to 3D to 5A to 5D are diagrams illustrating a straight-type ink circulation configuration according to Example 1. FIGS. 3A to 5D are simplified diagrams provide to explain a mechanism of generation a circulation flow and effects thereof in the straight-type ink circulation configuration. Thus, the configuration of the liquid ejection head 1 shown in FIGS. 3A to 5D may partially differ from the configuration of the liquid ejection head 1 according to Example 1, as described herein with reference to FIGS. 9A to 11B. However, the mechanism of generating ink circulation and effects thereof described with reference to FIGS. 3A to 5D are similar in the liquid ejection head 1 according to Example 1. The following descriptions referring to FIGS. 3A to 5D incorporate by reference contents applicable to the liquid ejection head 1 according to Example 1, unless otherwise indicated.

FIG. 3A is a diagram illustrating a configuration near the ejection nozzle 11 of the liquid ejection head 1, seen in the Z direction. FIG. 3B is a cross-sectional view taken along line AA in FIG. 3A. FIG. 3C is a cross-sectional view taken along line AA in FIG. 3A and is a cross-sectional view of a liquid ejection head 1 having a configuration different from that illustrated in FIG. 3B. FIG. 3D is a cross-sectional view taken along line AA in FIG. 3A and is a diagram illustrating the flow of ink of a case in which the ink is ejected from the ejection nozzle.

The liquid ejection head 1 has a stacked substrate 18 and an orifice plate 19, and an ejection nozzle array 63 formed of a plurality of ejection nozzles 11 arranged in a first direction (the Y direction) is formed in the orifice plate 19. An ink meniscus is spread on the ejection nozzles 11, and an ejection nozzle interface as the interface between the ink and the atmosphere is formed.

Between the substrate 18 and the orifice plate 19, a plurality of individual flow passages 23 that are separated by partition walls 21, communicate with a plurality of ejection nozzles 11, and extend in a second direction (the X direction) are formed. The individual flow passage 23 linearly extends in the second direction (the X direction) intersecting with the first direction (the Y direction) in which a plurality of ejection nozzles 11 are aligned in the ejection nozzle array 63. In the example illustrated in FIGS. 3A to 3D, the second direction is a direction orthogonal to the first direction.

In addition, a first flow passage 61 with which one of each end of the plurality of individual flow passages 23 communicates and a second flow passage 62 with which the each other end of the plurality of individual flow passages 23 communicates are formed. The first flow passage 61 and the second flow passage 62 extend in the Y direction and are located on sides opposite to each other in the X direction across the ejection nozzle array 63.

In the individual flow passage 23, a pressure chamber 12 is formed at a position corresponding to the ejection nozzle 11. The pressure chamber 12 communicates with the first flow passage 61 through a connection flow passage 13 and communicates with the second flow passage 62 through a connection flow passage 10. In other words, the individual flow passage 23 includes the pressure chamber 12, the connection flow passage 10, and the connection flow passage 13.

In the substrate 18, a first energy generating element 14 (ejection energy generating element) that generates energy for ejecting ink disposed inside of the pressure chamber 12 is provided at a position corresponding to the ejection nozzle 11. Here, an electrothermal conversion element is used as the first energy generating element 14. By driving the first energy generating element 14 to generate heat and cause the ink disposed inside of the pressure chamber 12 to generate air bubbles, ink can be ejected from the ejection nozzle 11 using the bubbling energy. The first energy generating element 14 is not limited to electrothermal conversion element, and a piezoelectric element or the like can be used.

In addition, a second energy generating element 24 (a flow energy generating element) for generating energy to generate a circulation flow 27 (flow) indicated by arrows in the ink disposed inside of the individual flow passage 23 is provided in the substrate 18. Here, an electrothermal conversion element is used as the second energy generating element 24. The second energy generating element 24 is provided at a position different from that of the first energy generating element 14 in the X direction.

In the first flow passage 61, a plurality of first openings 22 for allowing ink to flow into or flow out from a common flow passage 29 are arranged in the Y direction. In the second flow passage 62, a plurality of second openings 32 for allowing ink to flow into or flow out from the common flow passage 29 are arranged in the Y direction. The first openings 22 and the second openings 32 penetrate through the substrate 18 in a stacking Z direction.

The first energy generating element 14, the ejection nozzle 11, and the pressure chamber 12 are located closer to the second opening 32 than to the first opening 22. The second energy generating element 24 is located closer to the first opening 22 than to the second opening 32. The individual flow passage 23 communicates, on one end side in the X direction (the −X direction side), with the first opening 22 and communicates, on the other end side (the +X direction side), with the second opening 32. The connection flow passage 13 is located on further toward the second energy generating element 24 side than the ejection nozzle array 63 in the X direction. Both ends of the individual flow passage 23 in the X direction are located on sides opposite to each other across the ejection nozzle array 63.

There are two primary types of ink flow in the individual flow passage 23: (1) a first ink flow for refilling after ink ejection that is driven by the first energy generating element 14 and (2) a second ink flow that is a circulation flow 27 generated by driving the second energy generating element 24.

In a case in which the first energy generating element 14 is driven, and ink is ejected from the ejection nozzle 11, as shown in FIG. 3D, the flow 37 of ink flowing from both the first opening 22 and the second opening 32 into the pressure chamber 12 of the individual flow passage 23 is generated. In accordance with this, ink is supplied to the individual flow passage 23 from both the first opening 22 and the second opening 32.

In a case in which the second energy generating element 24 is driven, and the circulation flow 27 is formed, ink flows from an inlet 37 of the connection flow passage 13 side (the first opening 22 side) into the individual flow passage 23, and ink flows out from an outlet 38 of the connection flow passage 10 side (the second opening 32 side). The ink that has flown out from the second opening 32 returns to the first opening 22 through the common flow passage 29. A circulation flow 27 is accordingly generated inside of the individual flow passage 23.

In the configuration shown in FIG. 3B, the first opening 22 and the second opening 32 are connected to the common flow passage 29 inside of the chip of the liquid ejection head 1. In the configuration shown in FIG. 3C, the first opening 22 and second opening 32 are connected to a flow passage 291 and a flow passage 292, which are independent, inside of the chip of the liquid ejection head 1 and are connected to a common flow passage outside of the chip of the liquid ejection head 1. The present disclosure is applicable to any of the configurations.

A filter for removing foreign materials inside of ink can be provided in circulation flow passages of the ink inside and outside of the liquid ejection head 1. In the example shown in FIGS. 3A to 3D, the filter 31 is provided near the one end side (the second energy generating element 24 side) of the individual flow passage 23 in the X direction and near the other end side (the first energy generating element 14 side) thereof. In addition, a filter may be arranged between the first energy generating element 14 and the second energy generating element 24 in the individual flow passage 23. In this case, no filter may be arranged near the one end side (the second energy generating element 24 side) of the individual flow passage 23 in the X-direction.

In the liquid ejection head 1, a first energy generating element 14 and a second energy generating element 24 are arranged to be aligned in the X direction inside of an individual flow passage 23 extending linearly in the X direction. By driving the second energy generating element 24, a circulation flow 27 of ink can be generated in the individual flow passage 23. Both ends of the individual flow passage 23 are located on sides opposite to each other in the X direction with respect to the ejection nozzle array 63. For this reason, an inlet 37 (upstream end) and an outlet 38 (downstream end) of the circulation flow 27 are respectively connected to a first flow passage 61 and a second flow passage 62, which are different from each other, and are separated from each other. Such an ink circulation configuration is referred to as a straight type.

### <Process of Generating Circulation Flow>

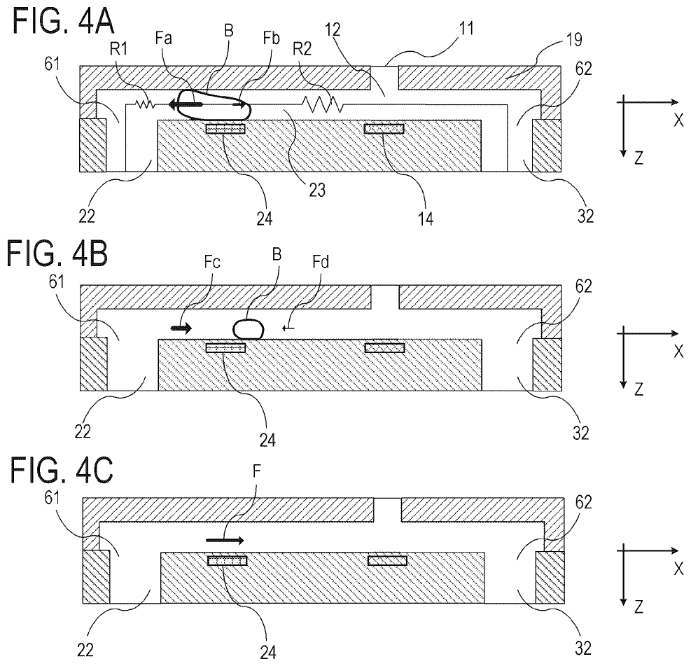

FIGS. 4A to 4C are diagrams for explaining the process of generating a circulation flow of ink by driving the second energy generating element 24. FIGS. 4A, 4B, and 4C are cross-sectional views that are similar to FIG. 3B and represent processes in which ink is heated by the second energy generating element 24, and air bubbles due to film boiling or the like of ink are generated, grown, shrunk, and removed.

FIG. 4A is a diagram illustrating a situation in which air bubbles B are generated by driving the second energy generating element 24 (a circulation heater). The second energy generating element 24 is located closer to the first opening 22 than to the second opening 32. For this reason, a flow resistance R1 between the second energy generating element 24 and the first opening 22 is lower than a flow resistance R2 between the second energy generating element 24 and the second opening 32. In FIG. 4A, an equivalent circuit that expresses such flow resistances R1 and R2 as electrical resistances is drawn. The air bubble B generated due to film boiling of ink film and the like, as illustrated in FIG. 4A, grows while being biased toward the first flow passage 61 side of the small flow resistance R1 due to a difference between the flow resistances R1 and R2. Thus, inside of the individual flow passage 23, a flow Fa of ink toward the first flow passage 61 becomes larger than a flow Fb of ink toward the second flow passage 62.

FIG. 4B is a diagram illustrating the flow of ink in the process of shrinkage of the air bubble B. In the shrinkage process of the air bubble B, the ink flows in to compensate for a volume corresponding to the shrinkage. At that time, as illustrated in FIG. 4B, a flow Fc of the ink flowing in from the first opening 22 that is on a side having the small flow resistance R1 is greater than a flow Fd of the ink flowing in from the second opening 32 that is on a side having the large flow resistance R2. Further, the removal position of the air bubble B deviates from the second energy generating element 24 to the second opening 32 side.

FIG. 4C is a diagram illustrating the flow of the ink after the removal of the air bubble B. According to a relationship Fc>Fd generated in FIG. 4B, a circulation flow F of the ink from the first opening 22 toward the second opening 32 is generated.

The magnitude of such a circulation flow F is influenced by the ratio of the flow resistances R1 and R2 and the size of the air bubble B. For example, when an electrothermal conversion element (heater) is used as the second energy generating element 24, the second energy generating element 24 is to be located closer to one of the both ends of the individual flow passage 23 than the first energy generating element 14. The flow resistance ratio R1/R2 is set within the range of 0.05 to 0.40. By setting the flow resistance ratio R1/R2 in this range, the circulation flow F can be maximized.

By increasing the flow Fa of the ink toward the first flow passage 61 illustrated in FIGS. 4A and 4B and increasing the flow Fc of the ink flowing in from the first opening 22, the circulation flow F can be increased. Therefore, it is effective to reduce the flow resistance R1. In addition, by decreasing the flow Fb of the ink toward the second flow passage 62 and decreasing the flow Fd of the ink flowing in from the second opening 32, the circulation flow F can be increased. Therefore, it is effective to increase the flow resistance R2. As described above, by decreasing the flow resistance R1 and increasing the flow resistance R2, that is, by decreasing the flow resistance ratio R1/R2, the circulation flow F can be increased.

In addition, when the accumulation of the air bubble B increases, the volume of the ink excluded from the individual flow passage 23 according to foaming increases, and thus, the circulation flow F increases. As methods for increasing the volume of the air bubble B, it may be considered, for instance, to increase the size of the second energy generating element 24, decrease the flow resistance R1 by increasing the width and the height of the connection flow passage 13, reduce the ink viscosity, increase the temperature of the liquid ejection head 1, and configure the drive pulse to be a double pulse.

Since a part of the circulation flow F of ink enters the ejection nozzle 11, the concentrated ink in the ejection nozzle 11 is sent to the second opening 32 side, and fresh ink flows into the ejection nozzle 11 from the first opening 22 side through the connection flow passage 13. With this, the concentrated ink is less likely to stay inside of the ejection nozzle 11 and, it is possible to suppress the influence of the concentrated ink and maintain the initial ink ejecting state.

The circulation flow F is a transient flow generated in accompaniment with the growth and shrink processes of the generated air bubbles B. Therefore, the inertial flow of the air bubbles B after removal of bubbles becomes weaker over time, and stops after a certain period of time. By repeatedly driving the second energy generating element 24, the circulation flow F can be generated steadily for a certain period of time. The driving cycle of the second energy generating element 24 is not particularly limited as long as the concentrated ink in the ejection nozzle 11 can be discharged. However, since a time from the generation of the air bubbles B to the removal of bubbles is about 10 μs, driving at a high drive frequency such as 100 kHz reduces the effects. Accordingly, to drive the second energy generating element 24, for example, at the period of about 100 Hz to several tens of kHz may be set.

The higher the drive frequency, the more the circulation flow F is stably maintained, and the greater the effect of discharging the concentrated ink. On the other hand, it is necessary to consider the rise in temperature of the ink due to the heat generated in accompaniment with the driving of the second energy generating element 24, to appropriately control the number of times of driving of the second energy generating element 24.

### U-Shaped Ink Circulation Configuration

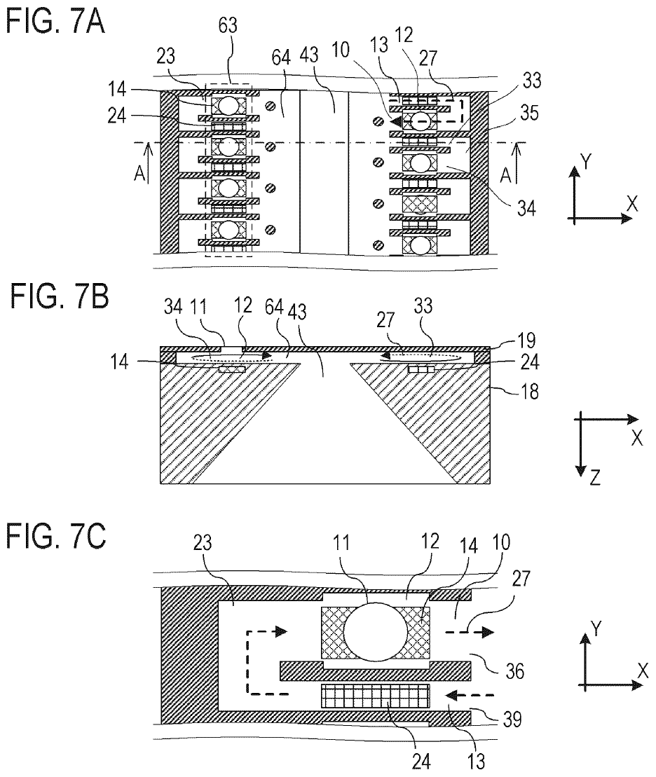

A U-shaped ink circulation configuration is described as a comparative example of the straight-type ink circulation configuration. FIGS. 7A to 7C are diagrams illustrating a liquid ejection head of a comparative example. FIG. 7A is a diagram illustrating a configuration near an ejection nozzle 11 of the liquid ejection head of the comparative example and is a diagram illustrating major constituent elements in a case in which the liquid ejection head 1 is seen in the Z direction. FIG. 7B is a cross-sectional view taken along line AA in FIG. 7A. FIG. 7C is a diagram illustrating the vicinity of an individual flow passage in FIG. 7A.

The liquid ejection head of the comparative example has a stacked substrate 18 and an orifice plate 19. An ejection nozzle array 63 formed of a plurality of ejection nozzles 11 arranged in the first direction (the Y direction) is formed in the orifice plate 19. A first energy generating element 14 and a second energy generating element 24 are alternately arranged in parallel with the ejection nozzle array 63.

Between the substrate 18 and the orifice plate 19, a plurality of individual flow passages 23 that are partitioned by partition walls 21, communicate respectively with a plurality of ejection nozzles 11, and formed in a U-shape are formed. The individual flow passage 23 has a first portion 33 and a second portion 34, which extend in the X direction, and a third portion 35 connecting the one end side of the first portion 33 and the second portion 34 in the X direction and extending in the Y direction. The other end side of the first portion 33 and the second portion 34 in the X direction communicates with the flow passage 64, and the flow passage 64 communicates with the common flow passage 43. Both ends of the individual flow passage 23 are adjacent to each other in the Y direction and communicate with the flow passage 64 on the same side (single side) in the X direction. The common flow passage 43 is disposed to penetrate through the substrate 18.

The second energy generating element 24 is disposed in the first portion 33, and the pressure chamber 12 and the first energy generating element 14 are disposed in the second portion 34. The individual flow passage 23 is a flow passage formed through U-shape bending so as to connect the first energy generating element 14 and the second energy generating element 24 arranged to be aligned in the Y direction.

In the individual flow passage 23, a pressure chamber 12 is formed at a position corresponding to the ejection nozzle 11. The pressure chamber 12 communicates with the flow passage 64 through the connection flow passage 10 and communicates with the flow passage 64 through the connection flow passage 13. In other words, the individual flow passage 23 includes the pressure chamber 12, the connection flow passage 10, and the connection flow passage 13. The connection flow passage 13 is formed in parts of the first portion 33, the third portion 35, and the second portion 34, and the connection flow passage 10 is formed in a part of the second portion 34. The first energy generating element 14 is located near a connection portion between the connection flow passage 10 and the flow passage 64, and the second energy generating element 24 is located near a connection portion between the connection flow passage 13 and the flow passage 64.

As flows of ink in the individual flow passage 23, there are: (1) a first ink flow for refilling after ink is ejected by driving the first energy generating element 14; and (2) a second ink flow that is a circulation flow 27 generated by driving the second energy generating element 24.

In a case in which ink is ejected from the ejection nozzle 11 by driving the first energy generating element 14, in order to supply ink accompanying ejection from the common flow passage 43, ink is caused to flow from both the connection flow passage 10 side and the connection flow passage 13 side into the pressure chamber 12.

In a case in which the circulation flow 27 is formed by driving the second energy generating element 24, ink flows from the inlet 39 of the connection flow passage 13 side into the individual flow passage 23, and ink flows out from the outlet 36 to the connection flow passage 10 side. In accordance with the circulation flow 27 indicated by arrows generated inside of the individual flow passage 23, flow-in or flow-out of ink into/from the common flow passage 43 used in common occur. In addition, a configuration for communicating with a common flow passage through a plurality of openings that are disposed in the flow passage 64 and are arranged in the Y direction as illustrated in FIGS. 3A to 3D may be employed. In such a case, the plurality of openings communicate with the common flow passage inside of the chip as illustrated in FIG. 3B.

In the liquid ejection head of the comparative example, inside of the individual flow passage 23 formed in the U-shape, the first energy generating element 14 and the second energy generating element 24 are aligned in the Y direction and are arranged to be aligned along the ejection nozzle array 63. By driving the second energy generating element 24, the circulation flow 27 of ink can be generated inside of the individual flow passage 23. Both ends of the individual flow passage 23 are located on the same side (single side) with respect to the ejection nozzle array 63 in the X direction. For this reason, the inlet 39 (the upstream end) and the outlet 36 (the downstream end) of the circulation flow 27 are connected to the common flow passage 64. Such an ink circulation configuration is referred to as a U-shape.

### Recirculation Concentration

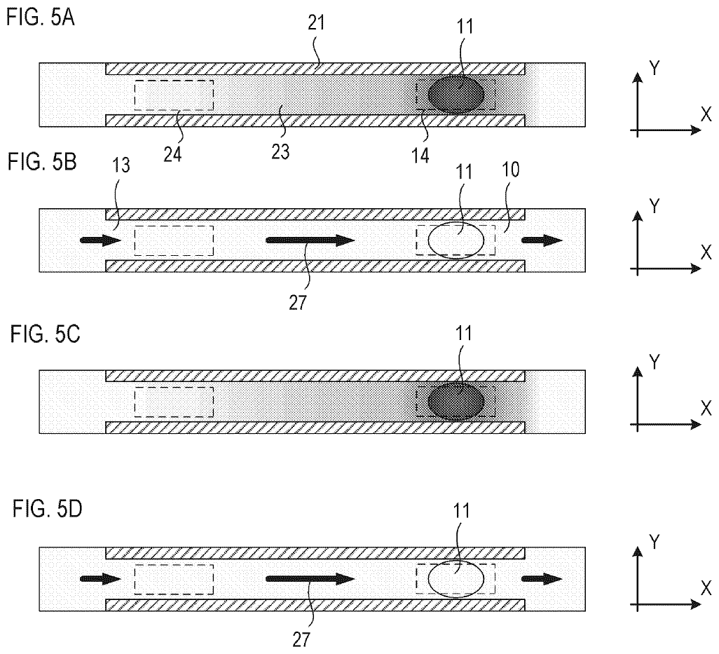

FIGS. 5A to 5D are diagrams illustrating a situation of a circulation flow and concentration of ink in the straight-type ink circulation configuration. In FIGS. 5A to 5D, the concentration of the ink is expressed by the density, and a portion in dark color is a portion having high concentration.

FIG. 5A illustrates a state of a case in which a recording operation using the liquid ejection apparatus 50 is temporarily suspended. When a recording operation is temporarily suspended, volatile components of ink evaporate from the ejection nozzle 11, and concentration of the ink progresses near the ejection nozzle 11.

FIG. 5B illustrates a state immediately after the circulation flow 27 is caused to be generated by the second energy generating element 24 thereafter. In accordance with the circulation flow 27, the concentration near the ejection nozzle 11 is eliminated. The ink concentrated near the ejection nozzle 11 is discharged from the outlet 38, fresh ink flows in from the inlet 37, and the concentration is eliminated in the entirety of the individual flow passage 23.

FIG. 5C illustrates a state of a case in which the recording operation is temporarily suspended again thereafter. Similar to the state illustrated in FIG. 5A, concentration of the ink progresses near the ejection nozzle 11.

FIG. 5D illustrates a state immediately after the circulation flow 27 is caused to be generated by the second energy generating element 24 again thereafter. Similar to the state illustrated in FIG. 5B, the concentration near the ejection nozzle 11 is eliminated, and the concentration is eliminated also in the entirety of the individual flow passage 23.

In this way, in the straight-type ink circulation configuration in which the inlet 37 and the outlet 38 of the individual flow passage 23 are separated, the concentrated state is eliminated also by repeating the temporary suspension and the circulation operation.

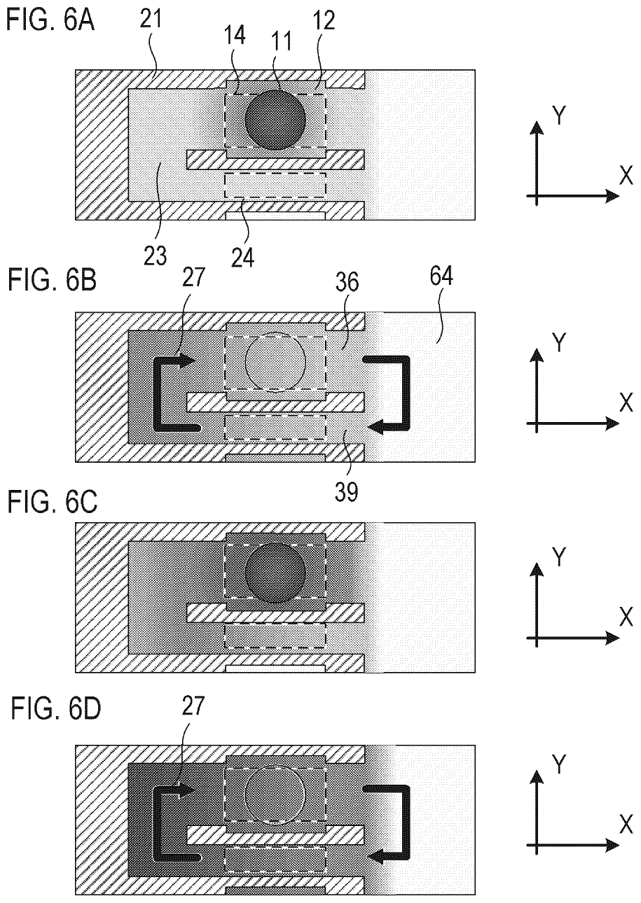

FIGS. 6A to 6D are diagrams explaining a situation of a circulation flow and concentration of ink in the U-shaped ink circulation configuration of the comparative example.

FIG. 6A illustrates a state of a case in which the recording operation using the liquid ejection apparatus is temporarily suspended. When the recording operation is temporarily suspended, concentration of ink progresses near the ejection nozzle 11.

FIG. 6B illustrates a state immediately after the circulation flow 27 is caused to be generated by the second energy generating element 24 thereafter. In the U-shaped ink circulation configuration, the inlet 39 and the outlet 36 of the individual flow passage 23 are connected to the common flow passage 64 and are proximate to each other. For this reason, although the ink concentrated near the ejection nozzle 11 is discharged from the outlet 36 of the individual flow passage 23, the ink may flow from the inlet 39 into the individual flow passage 23 again. In accordance with this, even when the circulation flow 27 is caused to be generated, the ink in the entirety of the individual flow passage 23 is replaced with non-fresh ink but with slightly concentrated ink. This phenomenon is referred to as recirculation concentration.

FIG. 6C illustrates a state of a case in which the recording operation is temporarily suspended again thereafter. From the state illustrated in FIG. 6B, concentration of the ink near the ejection nozzle 11 is further progressed.

FIG. 6D illustrates a state immediately after the circulation flow 27 is caused to be generated by the second energy generating element 24 again thereafter. As explained in FIG. 6B, in accordance with the influence of the recirculation concentration, the ink in the entirety of the individual flow passage 23 is replaced with ink that is more concentrated than that of FIG. 6B.

In this way, in the U-shaped ink circulation configuration in which the inlet 39 and the outlet 36 of the individual flow passage 23 are adjacent to each other, in a case in which the temporary suspension and the circulation operation are repeated, the concentrated state is not eliminated, and the concentration gradually processes in the entirety of the individual flow passage 23. Further, even when the circulation operation is not repeated, the ink may be highly concentrated near the ejection nozzle 11 due to a long suspension time period or the like. In such a case, the state of concentration is unlikely to improve even in the first circulation operation. This is because the recirculation concentration hardly alleviates the degree of the concentrated state.

Accordingly, between the straight-type configuration in which the inlet and the outlet of the individual flow passage are separated from each other and the U-shaped configuration in which the inlet and the outlet of the individual flow passage are adjacent to each other, there is a difference in the aspect of elimination of concentration in a case in which a circulation operation is performed after temporarily suspension due to a difference in the influence of the discharged concentrated ink. In the straight-type configuration, the concentrated state in the entire individual flow passage is easily eliminated, and thus, the ejection stability is hardly degraded by a concentrated ink. On the other hand, in the U-shaped configuration, the concentrated state in the entirety of the individual flow passage is difficult to eliminate due to the recirculation concentration, and therefore, ejection is likely to become unstable depending on the concentration in the entirety of the individual flow passage.

### <Ink>

By using an electro-thermal conversion element (a circulation heater) as the second energy generating element 24, an ink circulation flow is generated inside of the individual flow passage 23, whereby the influence of the concentrated ink increased in viscosity due to evaporation of the volatile component in the ejection nozzle 11 can be suppressed. In accordance with this, the ejected state of the ink can be maintained favorably, and the change in the ejection speed and the like can be reduced, whereby the ejection can be stabilized.

Here, depending on the application of the liquid ejection head 1 or the liquid ejection apparatus 50, there may be cases in which the type of the coloring material of the ink to be used, the content of the solid content, and the like are different. For example, in plain paper, it is conceivable to use an ink having a reduced moisture content in order to suppress curling (warping) and cockling (wavy wrinkles) deriving from water in the ink. In the ink having a low moisture content, it is easy for the viscosity to rapidly increase in accompaniment with evaporation of moisture because the concentration of solid matter such as an organic solvent, a pigment, a resin and the like other than water is high, which is likely to lead to a decrease in the ejection stability of the ink. Generally, an ink having a solid content of 10 wt % (mass %) or more in the ink can be said to be an ink having a high solid content.

In the liquid ejection head 1 according to Example 1, since the circulation flow 27 can be generated inside of the individual flow passage 23 having the pressure chamber 12, even in a case in which ink containing a solid content of 10 wt % (mass %) or more is used in this way, increase in viscosity of the ink can be suppressed. Accordingly, the present disclosure can be appropriately applied to a liquid ejection head 1 and a liquid ejection apparatus 50 using an ink containing a solid content of 10 wt % (mass %) or more. According to the liquid ejection head 1 of Example 1, ejection stability can be maintained favorably regardless of the type of ink.

In addition, regarding the operating temperature of the liquid ejection head 1, the liquid ejection head may be heated at a constant temperature by arranging a heater in the entire chip and controlling the heater. Since the viscosity of ink varies depending on the temperature, the ink viscosity at the head operating temperature affects the ejection stability.

In the liquid ejection head 1 according to Example 1, the flow rate of the circulation flow 27 that can be formed in the individual flow passage 23 by the second energy generating element 24 is several tens mm/s to 1000 mm/s as an instantaneous flow rate. The flow rate averaged over a time width of the order of several 100 μseconds depends on the drive frequency of the second energy generating element 24. This is because the circulation flow 27 generated by the second energy generating element 24 is a transient flow that damps over time and stops after a predetermined time. The average flow rate of the circulation flow 27 that can be formed in a case in which the drive frequency of the second energy generating element 24 is set to about 10 to 20 kHz, which is in the same level as that of the drive frequency (ejection frequency) of the first energy generating element 14, is several mm/s to 100 mm/s.

In a case in which an ink having a high pigment concentration is used, increase in viscosity of the ink progresses in the ejection nozzle 11 in accordance with a non-ejection time (suspension time), and the ejection speed changes, and the ejection stability is likely to decrease. For example, an ink having such a concentration, at which the viscosity at the head operating temperature is at least 3 cP and not more than 6 cP, can be said to be an ink having a high pigment concentration. In a case in which such an ink is used, ink circulation is performed during a short suspension time. Thus, concentration is eliminated by performing steady ink circulation or high-frequency transient ink circulation. In the liquid ejection head 1 according to Example 1, by driving the second energy generating element 24, transient ink circulation can be caused to occur in the individual flow passage 23. For this reason, in the liquid ejection head 1 according to Example 1, by performing the circulation operation at a high frequency, the concentration in the ejection nozzle 11 in a case in which a high-concentration ink is used can be eliminated.

In a case in which an ink having a low pigment concentration is used, although a change in the ejection speed may occur in accordance with a non-ejection time (suspension time), the influence thereof is relatively small in comparison with that of a high-concentration ink. For example, an ink having such a concentration that the viscosity at the head operating temperature is at least 1 cP and less than 3 cP can be said to be an ink having a low pigment concentration. When the suspension time is longer, for example, the viscosity of the ink increases in the ejection nozzle 11, for example, in accordance with a non-printing drive time (stop time). When restarting after stopping without printing for a predetermined time, by performing a suction operation, a wiping operation, and a recovery operation such as preliminary ejection in combination therewith, the influence of the thickened ink can be suppressed, however, such recovery operations involve waste ink.

In the liquid ejection head 1 according to Example 1, by forming the circulation flow 27 in the individual flow passage 23 by driving the second energy generating element 24, the concentration in the ejection nozzle 11 is eliminated, and the increase in the viscosity ink can be suppressed. For this reason, depending on the suspension time, it is also possible to prevent waste ink from being generated by performing recovery processing of only a circulation operation. In addition, recovery processing with reduced waste ink can be performed by combining a suction operation or the like for removing air bubbles inside of the head other than the elimination of concentration while recovering by performing a circulation operation.

To suppress the influence of a concentrated ink without depending on the concentration of the ink, an initial fresh ink is supplied to the vicinity of the ejection nozzle 11. In a case in which a circulation heater is used as the second energy generating element 24, the lower the influence of the recirculation concentration, the better the effect of the circulation of ink can be acquired. Compared to the U-shaped ink circulation configuration, in the straight-type ink circulation configuration, the effect of maintaining the ejection performance according to ink circulation is exhibited more.

### <Drive Control>

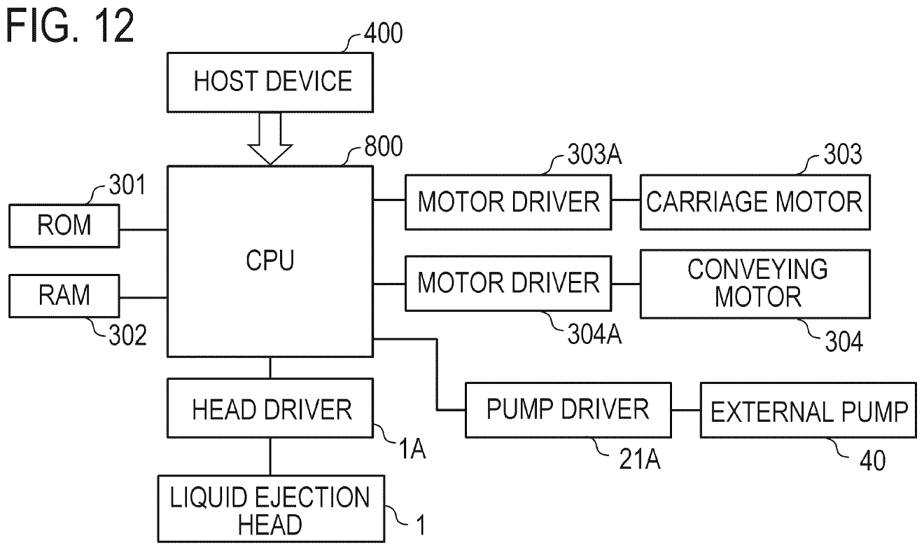

FIG. 12 is a block diagram illustrating a control configuration of the liquid ejection apparatus 50 according to Example 1. A CPU 800 is a control portion for controlling the operation of the portions of the liquid ejection apparatus 50, on the basis of a program such as a processing procedure stored in a ROM 301. A RAM 302 is used as a working area or the like, when the CPU 800 executes processing. The CPU 800 receives image data from a host device 400 disposed outside of the liquid ejection apparatus 50, and controls the liquid ejection head 1 by controlling a head driver 1A on the basis of the image data. The CPU 800 controls the drive of the first energy generating element 14 and the second energy generating element 24 of the liquid ejection head 1 using the head driver 1A.

The CPU 800 also controls drivers of various types of actuators provided in the liquid ejection apparatus 50. For example, the CPU 800 controls a motor driver 303A of a carriage motor 303 for moving the carriage 60, a motor driver 304A of a conveying motor 304 for conveying the recording medium P, and a pump driver 21A of the external pump 40. Although FIGS. 2A to 2D illustrate a configuration in which the image data is received from the host device 400, processing may be also executed on the liquid ejection apparatus 50 without using any data from the host device 400.

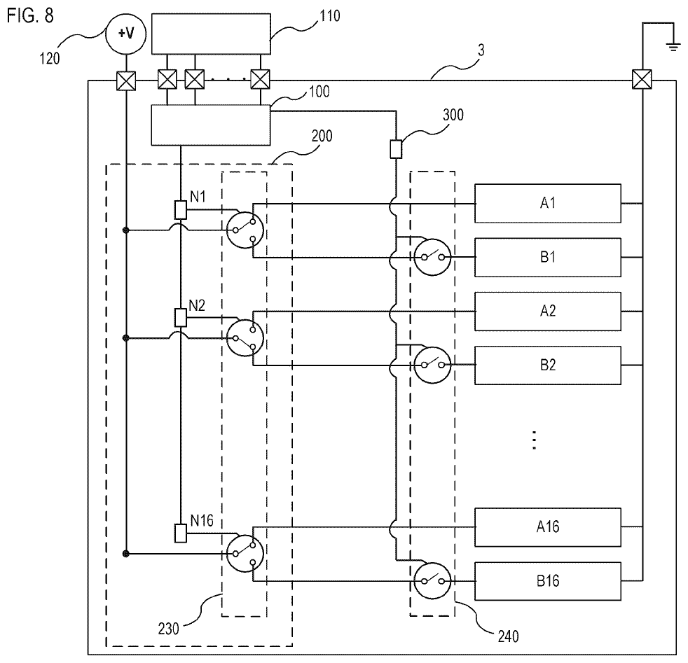

FIG. 8 is a diagram illustrating the control configuration of the liquid ejection head 1 according to Example 1. A substrate 18 of the liquid ejection chip 3 is provided with a controller 100, a selective drive circuit 200, an on/off drive circuit 240, a first energy generating element 14(An) (n=1 to 16), and a second energy generating element 24(Bn) (n=1 to 16). The liquid ejection chip 3 is connected to an external power source 120 and an external circuit 110. The external circuit 110 includes the head driver 1A illustrated in FIG. 12. A CPU 800 controlling the head driver 1A is a control unit for controlling the drive of the first energy generating element 14 and the second energy generating element 24.

The selective drive circuit 200 includes an on/on drive circuit 230 that selects the first energy generating element 14 and the second energy generating element 24. The on/on drive circuit 230 turns on any one of the first energy generating element 14 and the second energy generating element 24 to be driven in response to a control signal at each address Nn (n=1 to 16) received from the controller 100. The controller 100 controls a drive pulse used for driving the first energy generating element 14 or the second energy generating element 24 and a time interval for applying the drive pulse to each element.

The controller 100 controls the on/off drive circuit 240 using a drive enable/disable signal 300 of the second energy generating element 24. In accordance with this, the drive of the second energy generating element 24 in a case in which the second energy generating element 24 is selected in the on/on drive circuit 230 is controlled.

In this way, the drive of the second energy generating element 24 is controlled using the on/on drive circuit 230 and the on/off drive circuit 240.

In a case in which the drive enable/disable signal 300 is a signal for not driving the second energy generating element 24, even when the second energy generating element 24 is selected in the on/on drive circuit 230, the second energy generating element 24 is not driven. In this case, neither the first energy generating element 14 nor the second energy generating element 24 is driven. On the other hand, in a case in which the first energy generating element 14 is selected in the on/on drive circuit 230, the first energy generating element 14 is driven.

In a case in which the drive enable/disable signal 300 is a signal for driving the second energy generating element 24, when the second energy generating element 24 is selected in the on/on drive circuit 230, the second energy generating element 24 is driven. When the first energy generating element 14 is selected, the first energy generating element 14 is driven.

Thus, the second energy generating element 24 is controlled in accordance with the drive data of the first energy generating element 14 and the drive enable/disable signal 300. In accordance with this, since drive data for the second energy generating element 24 does not need to be prepared, the amount of drive data can be reduced by half.

In the example illustrated in FIG. 8, although a configuration in which 16 sets (32 elements in total) of first energy generating elements 14 and second energy generating elements 24 are controlled as one group is illustrated, the configuration is not limited thereto. For example, 8 sets (16 elements), 12 sets (24 elements) of first energy generating elements 14 and second energy generating elements 24 may be controlled as one group. In addition, also in a case in which there are a plurality of second energy generating elements 24, the common drive enable/disable signal 300 can be used.

FIGS. 9A to 9C are diagrams illustrating a liquid ejection head 1 according to Example 1. FIG. 9A is a diagram illustrating a configuration near an ejection nozzle 11 of the liquid ejection head 1 according to Example 1 and is a diagram illustrating major constituent elements of a case in which the liquid ejection head 1 is seen in the Z direction. FIG. 9B is a cross-sectional view taken along line AA in FIG. 9A. FIG. 9C is a cross-sectional view taken along line AA in FIG. 9A and is a cross-sectional view of a liquid ejection head 1 having a configuration different from that illustrated in FIG. 9B.

The liquid ejection head 1 according to Example 1 has a first ejection nozzle array 63a formed of a plurality of ejection nozzles 11 arranged in a first direction (the Y direction) and a second ejection nozzle array 63b. The second ejection nozzle array 63b is aligned with the first ejection nozzle array 63a in a second direction (the X direction) intersecting with the first direction (the Y direction).

The liquid ejection head 1 communicates respectively with the plurality of ejection nozzles 11 of the first ejection nozzle array 63a and has a plurality of first individual flow passages 23a that extend in the X direction and a plurality of second individual flow passages 23b that communicate respectively with the plurality of ejection nozzles 11 of the second ejection nozzle array 63b and extend in the X direction.

At positions corresponding to the ejection nozzle 11 in the plurality of first individual flow passages 23a and the plurality of second individual flow passages 23b, first energy generating elements 14 generating energy used for ejecting liquid from the ejection nozzle 11 are disposed. In the X direction in the plurality of first individual flow passages 23a and the plurality of second individual flow passages 23b, second energy generating elements 24 generating energy for causing the liquid to flow are disposed in alignment with the first energy generating elements 14.

On a side opposite to the second ejection nozzle array 63b across the first ejection nozzle array 63a in the X direction, a first flow passage 71 with which one ends 37a of the plurality of first individual flow passages 23a communicate is disposed. Between the first ejection nozzle array 63a and the second ejection nozzle array 63b in the X direction, a second flow passage 72 with which the other ends 38a of the plurality of first individual flow passages 23a and one ends 38b of the plurality of second individual flow passages 23b communicate is disposed. On a side opposite to the first ejection nozzle array 63a across the second ejection nozzle array 63b in the X direction, a third flow passage 73 with which the other ends 37b of the plurality of second individual flow passages 23b communicate is disposed.

In the first flow passage 71, a plurality of first openings 22 arranged in the Y direction in which liquid is caused to flow into or flow out of the first flow passage 71 are disposed. In the second flow passage 72, a plurality of second openings 32 arranged in the Y direction in which liquid is caused to flow into or flow out of the second flow passage 72 are disposed. In the third flow passage 73, a plurality of third openings 42 arranged in the Y direction in which liquid is caused to flow into or flow out of the third flow passage 73 are disposed.

The first energy generating element 14 disposed in the first individual flow passage 23a and the first energy generating element 14 disposed in the second individual flow passage 23b are located together at positions close to the second opening 32. In addition, the second energy generating element 24 disposed in the first individual flow passage 23a is located at a position close to the first opening 22, and the second energy generating element 24 disposed in the second individual flow passage 23b is located at a position close to the third opening 42.

In each of the plurality of first individual flow passages 23a, the second energy generating element 24 is disposed at a position closer to the first flow passage 71 than the first energy generating element 14 in the X direction. Thus, the flow resistance R1 between the second energy generating element 24 and the end, which is on the first flow passage 71 side, of the first individual flow passage 23a is lower than the flow resistance R2 between the second energy generating element 24 and the end, which is on the second flow passage 72 side, of the first individual flow passage 23a.

In each of the plurality of second individual flow passages 23b, the second energy generating element 24 is disposed at a position closer to the third flow passage 73 than the first energy generating element 14 in the X direction. Thus, the flow resistance R1 between the second energy generating element 24 and the end, which is on the third flow passage 73 side, of the second individual flow passage 23b is lower than the flow resistance R2 between the second energy generating element 24 and the end, which is on the second flow passage 72 side, of the first individual flow passage 23a.

Thus, as described in the reference example, in each of the plurality of first individual flow passages 23a, liquid flows in a direction from the first flow passage 71 side to the second flow passage 72 side in accordance with generated energy of the second energy generating element 24. In addition, in each of the plurality of second individual flow passages 23b, liquid flows in a direction from the third flow passage 73 side toward the second flow passage 72 side in accordance with generated energy of the second energy generating element 24. In other words, the circulation flow 27 becomes a flow from the second energy generating element 24 toward the first energy generating element 14. In accordance with this, a flow of the liquid flowing from the first opening 22 and the third opening 42 and flowing out to the second opening 32 is generated.

A size of a non-open portion 81 between two first openings 22 adjacent to each other in the Y direction is denoted by D1, a size of a non-open portion 82 between two second openings 32 adjacent to each other in the Y direction is denoted by D2, and a size of a non-open portion 83 between two third openings 42 adjacent to each other in the Y direction is denoted by D3. The liquid ejection head 1 according to Example 1 satisfies Equations (1) and (2):

$$D 1 > D 2 \qquad ( 1 )$$

$$D 3 > D 2 \qquad ( 2 )$$

The non-open portion 81 between the two first openings 22 adjacent to each other is a portion between the closest ends of the first openings 22 adjacent to each other in the Y direction and is a portion serving as a beam between the common flow passage 29 and the first flow passage 71 in the Z direction. This similarly applies also to the non-open portions 82 and 83. In other words, Example 1 has a feature in which the beam between the first openings 22 and the beam between the third openings 42 are larger than the beam between the second openings 32.

In Example 1, the first opening 22, the second opening 32, and the third opening 42 have approximately the same rectangular shapes, the number of the first openings 22 and the number of the third openings 42 per unit length in the Y direction are the same, and the number thereof is smaller than the number of the second openings 32. For example, the second openings 32 are arranged at a 300 dpi pitch, and the first openings 22 and the third openings 42 are arranged at a 150 dpi pitch. In this case, D1=D3.

The operations and effects of the liquid ejection head 1 according to Example 1 are described. The substrate 18 is a member having a large heat capacity. In addition, a portion of the substrate 18 that is near an outer edge brought into contact with the outside has a higher heat dissipation effect from the substrate 18 to the outside than a central portion. In the liquid ejection head 1 of Example 1, a beam between the first flow passage 71 close to the outer edge and the first opening 22 in the third flow passage 73 and the beam between the third openings 42 are larger than the beam between the second openings 32 in the second flow passage of the center portion. For this reason, the thermal resistance to a portion of the substrate 18 having a large heat capacity, with the portion being close to the outer edge having a high heat radiation effect, is smaller than the thermal resistance to a center portion of the substrate 18. Accordingly, heat generated in accordance with the drive of the second energy generating element 24 can be efficiently radiated to a portion near the outer edge of the substrate 18. In accordance with this, an excessive temperature rise of the liquid ejection chip 3 and the liquid ejection head 1 due to heat generated by driving the second energy generating element 24 can be suppressed, and temperature unevenness inside the liquid ejection chip 3 can be suppressed.

By driving the second energy generating element 24, a circulation flow 27 is generated, and the ink concentration inside of the ejection nozzle 11 can be eliminated. In order to increase the action of the circulation flow 27, it is effective to increase the number of times of driving the second energy generating element 24. However, in a case in which the second energy generating element 24 is driven, unlike the drive of the first energy generating element 14, ejection of ink does not occur. For this reason, the heat dissipation effect according to ejection of ink is small, heat may be easily accumulated in the liquid ejection chip 3, and the temperature of the liquid ejection chip 3 may easily rise. When the temperature of the inside of the liquid ejection chip 3 rises, the rate of evaporation from the ejection nozzle 11 increases, and thus it becomes easy for the concentration of ink near the ejection nozzle 11 to progress.

In this respect, the liquid ejection head 1 according to Example 1, as described above, can efficiently release the heat generated by driving the second energy generating element 24 from the outer edge of the substrate 18, and thus, the accumulation of the heat inside of the liquid ejection chip 3 can be suppressed. Accordingly, even when the number of times of driving the second energy generating element 24 is increased, progress of ink concentration due to accumulation of heat can be suppressed.

In addition, the plurality of second energy generating elements 24 arranged for each ejection nozzle 11 can individually control on/off of the drive, for example, in accordance with the degree of concentration for each ejection nozzle 11. However, in a case in which the drive of the second energy generating elements 24 are individually controlled to be on/off, there is a possibility that a temperature distribution occurs in the liquid ejection chip 3 due to the influence of heat generated by driving the second energy generating elements 24 to increase the temperature unevenness.

In this respect, since the liquid ejection head 1 according to Example 1, as described above, can efficiently release the heat generated by driving the second energy generating elements 24 from the outer edge of the substrate 18, the temperature unevenness inside of the liquid ejection chip 3 can be suppressed.

Due to recent improvements in productivity, chip lengths have increased, and inter-row spacing has decreased in accordance with cost reduction efforts, and accordingly, in multi-color chips, excessive temperature rises and temperature unevenness due to the influence of the heat as described above are more likely to occur. By applying the liquid ejection head 1 according to Example 1 to such multi-color chips, excessive temperature rise and temperature unevenness due to the influence of heat can be suppressed to be appropriate.

The shape of the rear side of the substrate 18 changes in accordance with an etching method for the substrate 18. FIG. 9B illustrates a configuration in which a common flow passage 29 is formed in the substrate 18 through Si processing using anisotropic etching, and a first opening 22, a second opening 32, and a third opening 42 are formed through dry processing. FIG. 9C illustrates a configuration in which a common flow passage 29 is formed in the substrate 18 through Si processing using dry etching, and a first opening 22, a second opening 32, and a third opening 42 are further formed. By applying the liquid ejection head according to Example 1 to the configuration having the substrate 18 of any one of the shapes, the effects described above can be elicited.

In addition, by enlarging of the beam between the first openings 22 and the beam between the third openings 42, there is also an advantage that the wiring for driving the first energy generating element 14 and the second energy generating element 24 can be easily routed. In other words, wiring can be provided in an area (beam) between two first openings 22 adjacent to each other and an area (beam) between two third openings 42 adjacent to each other.

In the liquid ejection head 1 according to Example 1, the positions of the first opening 22 and the third opening 42 in the Y direction may be the same positions as illustrated in FIG. 9A or may be positions different from each other. For example, the positions of the first opening 22 and the third opening 42 in the Y direction may deviate from each other in accordance with the positions of the ejection nozzles 11 of the first ejection nozzle array 63a and the second ejection nozzle array 63b in the Y direction. This similarly applies also to Examples other than Example 1.

### Modification of Example 1

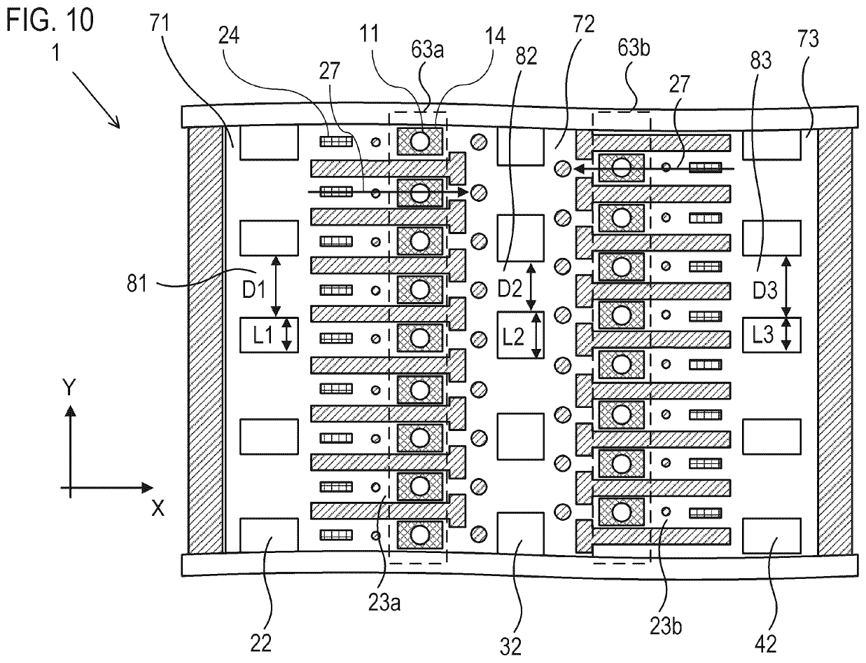

A modification of Example 1 is described. FIG. 10 is a diagram illustrating a configuration near an ejection nozzle 11 of a liquid ejection head 1 of a modification and is a diagram illustrating major constituent elements of a case in which the liquid ejection head 1 is seen in the Z direction.

In Example 1, as illustrated in FIG. 9A, by decreasing the numbers of the first openings 22 and the third openings 42 per unit length to be less than the number of the second openings 32, Equations (1) and (2), above, are realized.

In contrast, in the modification, as illustrated in FIG. 10, by configuring the shapes of the first opening 22 and the third opening 42 to be different from the shape of the second opening 32, Equations (1) and (2), above, are realized. In the example illustrated in FIG. 10, the aspect ratios of the first opening 22 and the third opening 42 are configured to be different from the aspect ratio of the second opening 32. The size L1 of the rectangular first opening 22 in the Y direction and the size L3 of the third opening 42 in the Y direction are configured to be smaller than the size L2 of the rectangular second opening 32 in the Y direction.

In accordance with this, even when the numbers of the first openings 22, the second openings 32, and the third openings 42 per unit length are the same, Equations (1) and (2), above, are satisfied. For example, the second openings 32 are arranged at a 300 dpi pitch, and the first openings 22 and the third openings 42 are also arranged at a 300 dpi pitch.

### Example 2

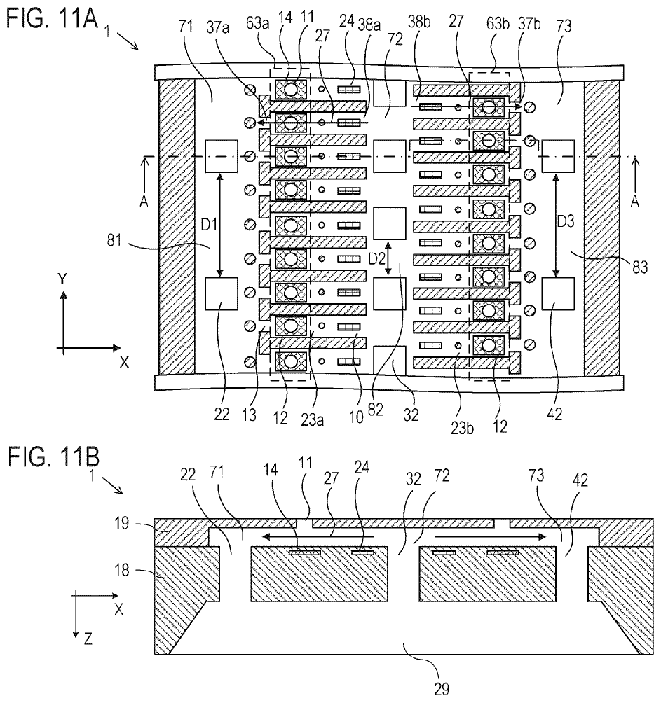

FIGS. 11A and 11B are diagrams illustrating a liquid ejection head 1 according to Example 2. FIG. 11A is a diagram illustrating a configuration near an ejection nozzle 11 of the liquid ejection head 1 according to Example 2 and is a diagram illustrating major constituent elements of a case in which the liquid ejection head 1 is seen in the Z direction. FIG. 11B is a cross-sectional view taken along line AA in FIG. 11A.

In Example 2, a difference from Example 1 is that a second energy generating element 24 disposed in a first individual flow passage 23a as well as a second energy generating element 24 disposed in a second individual flow passage 23b are located at positions close to a second opening 32. In addition, a first energy generating element 14 disposed in the first individual flow passage 23a is located at a position close to a first opening 22, and a first energy generating element 14 disposed in the second individual flow passage 23b is located at a position close to a third opening 42.

In each of a plurality of first individual flow passages 23a, the second energy generating element 24 is disposed at a position closer to a second flow passage 72 than the first energy generating element 14 in the X direction. Accordingly, a flow resistance R1 between the second energy generating element 24 and an end, which is on the second flow passage 72 side, of the first individual flow passage 23a is lower than a flow resistance R2 between the second energy generating element 24 and an end, which is on the first flow passage 71 side, of the first individual flow passage 23a.

In each of a plurality of second individual flow passages 23b, the second energy generating element 24 is disposed at a position closer to the second flow passage 72 than the first energy generating element 14 in the X direction. Accordingly, a flow resistance R1 between the second energy generating element 24 and an end, which is on the second flow passage 72 side, of the second individual flow passage 23 bis lower than a flow resistance R2 between the second energy generating element 24 and an end, which is on the third flow passage 73 side, of the first individual flow passage 23a.

Accordingly, in each of the plurality of first individual flow passages 23a, the liquid flows in a direction from the second flow passage 72 side to the first flow passage 71 side by energy generated by the second energy generating element 24. In each of the plurality of second individual flow passages 23b, the liquid flows in a direction from the second flow passage 72 side to the third flow passage 73 side by energy generated by the second energy generating element 24. In other words, the circulation flow 27 becomes a flow from the second energy generating element 24 to the first energy generating element 14. As a result, a flow of the liquid that flows in from the second opening 32 and flows out to the first opening 22 and the third opening 42 is generated. Equations (1) and (2), above, are satisfied, similar to Example 1.

The operations and effects of the liquid ejection head 1 according to Example 2 are described. Since the circulation flow 27 flows toward the outer edge of the substrate 18, heat dissipation can be further promoted. In accordance with this, excessive temperature rise of the liquid ejection chip 3 and the liquid ejection head 1 due to heat generated by driving the second energy generating element 24 can be suppressed, and temperature unevenness inside of the liquid ejection chip 3 can be suppressed.

Since ink concentrated near the ejection nozzle 11 is ejected after bifurcating to the first flow passage 71 and the third flow passage 73 of both sides, the influence of concentrated ink at the time of re-flowing into the inside of the individual flow passage in accordance with ejection or the like can be suppressed.

According to the present disclosure, in a liquid ejection head including a first energy generating element used for ejecting liquid to an individual flow passage communicating with an ejection nozzle and a second energy generating element used for causing the liquid to flow, excessive temperature rise can be suppressed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the priority to and the benefit of Japanese Patent Application No. 2024-160046, filed on Sep. 17, 2024, which is hereby incorporated by reference herein in its entirety.

What is claimed is:

1. A liquid ejection head comprising:
a first ejection nozzle array formed of a plurality of ejection nozzles arranged in a first direction;
a second ejection nozzle array formed of a plurality of ejection nozzles arranged in the first direction, the second ejection nozzle array being aligned with the first ejection nozzle array in a second direction intersecting with the first direction;
a plurality of first individual flow passages communicating with respective ejection nozzles of the plurality of ejection nozzles of the first ejection nozzle array and extending in the second direction;
a plurality of second individual flow passages communicating with respective ejection nozzles of the plurality of ejection nozzles of the second ejection nozzle array and extending in the second direction;
a plurality of first energy generating elements disposed at positions corresponding to respective ejection nozzles in the plurality of first individual flow passages and the plurality of second individual flow passages, the first energy generating elements configured to generate energy for ejecting liquid from the ejection nozzles;
a plurality of second energy generating elements aligned with respective first energy generating elements in the second direction in the plurality of first individual flow passages and the plurality of second individual flow passages, the second energy generating elements configured to generate energy for causing liquid to flow;
a first flow passage disposed on a side of the second ejection nozzle array opposite to the first ejection nozzle array in the second direction, the first flow passage configured to communicate with first ends of the plurality of first individual flow passages;
a second flow passage disposed between the first ejection nozzle array and the second ejection nozzle array in the second direction, the second flow passage configured to communicate with second ends of the plurality of first individual flow passages and first ends of the plurality of second individual flow passages;
a third flow passage disposed on a side of the first ejection nozzle array opposite to the second ejection nozzle array in the second direction, the third flow passage configured to communicate with second ends of the plurality of second individual flow passages;
a plurality of first openings arranged in the first direction and disposed in the first flow passage, a first opening of the plurality of first openings configured for liquid to flow into or flow out of the first flow passage;
a plurality of second openings arranged in the first direction and disposed in the second flow passage, a second opening of the plurality of second openings configured for liquid to flow into or flow out of the second flow passage; and
a plurality of third openings arranged in the first direction and disposed in the third flow passage, a third opening of the plurality of third openings configured for liquid to flow into or flow out of the third flow passage;
wherein:
$$D 1 > D 2 and D 3 > D 2 ,$$
with D1 being a size of a non-open part between two first openings adjacent to each other in the first direction, D2 being a size of a non-open part between two second openings adjacent to each other in the first direction, and D3 being a size of a non-open part between two third openings adjacent to each other in the first direction.

2. The liquid ejection head according to claim 1,
wherein D1=D3.

3. The liquid ejection head according to claim 1,
wherein a number of first openings per unit length in the first direction is less than a number of second openings per unit length in the first direction, and
wherein a number of third openings per unit length in the first direction is less than a number of the second openings per unit length in the first direction.

4. The liquid ejection head according to claim 1,
wherein a size of first openings in the first direction is smaller than a size of second openings in the first direction, and
wherein a size of third openings in the first direction is smaller than a size of second openings in the first direction.

5. The liquid ejection head according to claim 1,
wherein, in each of the plurality of first individual flow passages, the second energy generating element is disposed at a position closer to the first flow passage than the first energy generating element in the second direction,
wherein, in each of the plurality of first individual flow passages, a flow resistance R1 between the second energy generating element and an end, adjacent to the first flow passage is lower than a flow resistance R2 between the second energy generating element and an end adjacent to the second flow passage,
wherein, in each of the plurality of second individual flow passages, the second energy generating element is disposed at a position closer to the third flow passage than the first energy generating element in the second direction,
wherein, in each of the plurality of second individual flow passages, a flow resistance R1 between the second energy generating element and an end adjacent to the third flow passage is lower than a flow resistance R2 between the second energy generating element and an end adjacent to the second flow passage,
wherein, in each of the plurality of first individual flow passages, liquid flows in a direction from the end adjacent to the first flow passage to the end adjacent to the second flow passage by energy generated by the second energy generating element, and
wherein, in each of the plurality of second individual flow passages, liquid flows in a direction from the end adjacent to the third flow passage to the end adjacent to the second flow passage by energy generated by the second energy generating element.

6. The liquid ejection head according to claim 1,
wherein, in each of the plurality of first individual flow passages, the second energy generating element is disposed at a position closer to the second flow passage than the first energy generating element in the second direction,
wherein, in each of the plurality of first individual flow passages, a flow resistance R1 between the second energy generating element and an end adjacent to the second flow passage is lower than a flow resistance R2 between the second energy generating element and an end adjacent to the first flow passage,
wherein, in each of the plurality of second individual flow passages, the second energy generating element is disposed at a position closer to the second flow passage than the first energy generating element in the second direction,
wherein, in each of the plurality of second individual flow passages, a flow resistance R1 between the second energy generating element and an end adjacent to the second flow passage is lower than a flow resistance R2 between the second energy generating element and an end adjacent to the third flow passage,
wherein, in each of the plurality of first individual flow passages, liquid flows in a direction from the end adjacent to the second flow passage to the end adjacent to the first flow passage by energy generated by the second energy generating element, and
wherein, in each of the plurality of second individual flow passages, liquid flows in a direction from the end adjacent to the second flow passage to the end adjacent to the third flow passage by energy generated by the second energy generating element.

7. The liquid ejection head according to claim 1,
wherein the plurality of second energy generating elements are electro-thermal conversion elements.

8. The liquid ejection head according to claim 5,
wherein the plurality of second energy generating elements are electro-thermal conversion elements, and a ratio R1/R2 between the flow resistances R1 and R2 is a value in a range of 0.05 to 0.40.

9. The liquid ejection head according to claim 1,
wherein the plurality of first energy generating elements are electro-thermal conversion elements.

10. The liquid ejection head according to claim 1, further comprising:
electrical wiring provided in an area between two adjacent first openings of the plurality of first openings and an area between two adjacent third openings of the plurality of third openings.

11. The liquid ejection head according to claim 1,
wherein the plurality of second energy generating elements are driven by a common control signal.

12. A liquid ejection apparatus comprising:
the liquid ejection head according to claim 1;
a supply unit for supplying liquid to the liquid ejection head; and
a control unit for controlling the first energy generating elements and the second energy generating elements.
